(19) United States
(12) Patent Application Publication
(10) Pub. No.: US 2020/0329729 A1
(43) Pub. Date: Oct. 22, 2020

(54) Chocolate with buckwheat tea seeds and cooking method thereof

(71) Applicant: Seda Movladievna Khunkaeva, Moscow (RU)

(72) Inventor: Seda Movladievna Khunkaeva, Moscow (RU)

(21) Appl. No.: 16/502,945

(22) Filed: Jul. 3, 2019

Related U.S. Application Data
(60) Provisional application No. 62/836,316, filed on Apr. 19, 2019.

(51) Int. Cl. A23G 1/48; A23G 1/46; A23N 12/08; A23G 1/22; A23G 1/00

(52) U.S. Cl. CPC A23G 1/48; A23G 1/46; A23N 12/08; A23G 1/22; A23G 2200/14; A23G 1/0089; A23G 2200/06; A23G 2200/08; A23G 1/0063

(57) ABSTRACT

The present technical solution refers to food and confectionary industry. In particular, it refers to the method for cooking chocolate with processed buckwheat tea seeds based on original compositions and handcraft technology of production.

The technical problem of this technical solution lies in production of a chocolate product that has a consistent quality, contains only natural ingredients and is enriched by both macro- and microelements. Such product also has useful properties for the consumers, ingenious taste and smell and gastronomical attractiveness in comparison with other existing types of chocolate.

The present application claims priority to the provisional application U.S. 62/836,316, filed on 19 Apr. 2019 entitled “Chocolate with buckwheat tea seeds and cooking method thereof”. This application is incorporated by reference herein in its entirety.

### TECHNICAL FIELD

The present technical solution refers to food and confectionary industry. In particular, it refers to the method for cooking chocolate with processed buckwheat tea seeds based on original compositions and handcraft technology of production.

### PRIOR ART (BACKGROUND)

It is well-known from a prior art, that seeds of buckwheat can be used as one of the potential ingredients in process of chocolate production.

Russian patent RU2462040 “Chocolate composition with a nutritional deficiency and method of producing the same” (Russian Federation) discloses a complex of wheat, rye, barley, buckwheat bran for the chocolate composition. Buckwheat is not used as the key component of chocolate composition in this invention. It does not also appeal to the useful properties for the human body.

It is already known, that there are various methods of producing chocolate compositions with the use of different vegetative elements aiming to improve physical, biological, healing, organoleptical characteristics of product.

Russian patent RU2548387 “Composition to produce chocolate” discloses that dry rosehip meal is used in order to raise the healing characteristics of a product.

Russian patent RU2622697 “Composition to produce chocolate” discloses an extract of male fern and an extract of liquorice root for the chocolate composition. It is aimed at producing novel taste perception and improving strengthening and functional characteristics of a product.

Russian patent RU2524097 “Chocolate compositions containing ethyl cellulose” discloses that ethyl cellulose is used in the chocolate composition in order to improve thermal-resistant characteristics of a product.

The disadvantages of above-named methods of chocolate production are: in order to receive a final product, modes of industrial production are used. They negatively affect the quality characteristics of chocolate compositions.

The elevated temperature in industrial boilers nullifies taste and smell characteristics of chocolate and its components (rosehip, wheat barn, buckwheat). Metallic surfaces and grindstone, while heating, negatively affect human organism and destroy organoleptic and useful properties of chocolate composition components.

The present method for cooking chocolate with processed buckwheat tea seeds is free from the listed disadvantages. The problem, at solving which the technical solution is aimed, is to receive chocolate with ingenious taste and useful properties, enriched by vitamins, macro- and microelements that have been preserved due to the correctly selected temperature regime, special cocoa beans roast and handcraft technology of production with the use of melangeur.

### SUMMARY

The technical problem of this technical solution lies in production of a chocolate product that has a consistent quality, contains only natural ingredients and is enriched by both macro- and microelements. Such product also has useful properties for the consumers, ingenious taste and smell and gastronomical attractiveness in comparison with other existing types of chocolate.

A method for cooking dark chocolate with processed buckwheat tea seeds, comprising the following steps:
manually sorting cacao beans, filtering out those unfit for further processing;
roasting the selected cacao beans in a roasting machine at temperature not exceeding 143° C.;
separating the roasted cacao beans by grinding them in a grinder machine at least twice until their shells are mostly removed;
melting 5,000 g of cocoa butter, pouring it into a cocoa melnageur and starting rotation, wherein roller pressure cannot exceed 1 atm;
gradually adding 5,100 g of processed buckwheat tea seeds into the cocoa butter, all the while increasing the melangeur roller pressure up to 2 atm;
in 2 hours, gradually adding 8,400 g of cocoa solids;
in 2 hours, pouring in the remaining 10,420 g of cocoa butter and adding 16,200 g of cane sugar;
preserving the pressure and temperature levels, wherein the pressure is 2 atm and the temperature cannot exceed 65° C.;
in 48 hours since the chocolate-making process has been started, when chocolate particles are 30 μm in size, lifting the melangeur rollers and adding 90 g of sunflower lecithin;
in an hour, straining the chocolate through a fine sieve;
tempering the resulting chocolate mass by repeatedly heating it up to 40-45° C. and then cooling it down to 27-28° C., while constantly stirring the mass;
after the chocolate mass is tempered, pouring it into molds that are placed on a vibration table to remove excess air;
putting the molds with chocolate into a freezer until the chocolate is completely solid.

A method for cooking white chocolate with processed buckwheat tea seeds, comprising the following steps:
manually sorting cacao beans, filtering out those unfit for further processing;
roasting the selected cacao beans in a roasting machine at temperature not exceeding 143° C.;
separating the roasted cacao beans by grinding them in a grinder machine at least twice until their shells are mostly removed;
melting 5,000 g of cocoa butter, pouring it into a cocoa melnageur and starting rotation, wherein roller pressure cannot exceed 1 atm;
gradually adding 5,100 g of processed buckwheat tea seeds into the cocoa butter, all the while increasing the melangeur roller pressure up to 2 atm;
in 2 hours, pouring in the remaining 10,420 g of cocoa butter and gradually adding 14,700 g of whole milk powder or plant milk into the melangeur;
in 3 hours, adding 16,200 g of cane sugar;
preserving the pressure and temperature levels, wherein the pressure is 2 atm and the temperature cannot exceed 65° C.;
in 48 hours since the chocolate-making process has been started, when chocolate particles are 30 μm in size, lifting the melangeur rollers and adding 90 g of sunflower lecithin;
in an hour, straining the chocolate through a fine sieve;
tempering the resulting chocolate mass by repeatedly heating it up to 40-45° C. and then cooling it down to 27-28° C., while constantly stirring the mass;
after the chocolate mass is tempered, pouring it into molds that are placed on a vibration table to remove excess air;
putting the molds with chocolate into a freezer until the chocolate is completely solid.

A method for cooking milk chocolate with processed buckwheat tea seeds, comprising the following steps:
manually sorting cacao beans, filtering out those unfit for further processing;
roasting the selected cacao beans in a roasting machine at temperature not exceeding 143° C.;
separating the roasted cacao beans by grinding them in a grinder machine at least twice until their shells are mostly removed;
melting 5,000 g of cocoa butter, pouring it into a cocoa melnageur and starting rotation, wherein roller pressure cannot exceed 1 atm;
gradually adding 5,100 g of processed buckwheat tea seeds into the cocoa butter, all the while increasing the melangeur roller pressure up to 2 atm;
in 2 hours, pouring in the remaining 10,420 g of cocoa butter and gradually adding 14,700 g of whole milk powder or plant milk and 8,400 g of cocoa solids;
in 3 hours, adding 16,200 g of cane sugar and 60 g of vanilla bean paste;
preserving the pressure and temperature levels, wherein the pressure is 2 atm and the temperature cannot exceed 65° C.;
in 48 hours since the chocolate-making process has been started, when chocolate particles are 30 μm in size, lifting the melangeur rollers and adding 90 g of sunflower lecithin;
in an hour, straining the chocolate through a fine sieve;
tempering the resulting chocolate mass by repeatedly heating it up to 40-45° C. and then cooling it down to 27-28° C., while constantly stirring the mass;
after the chocolate mass is tempered, pouring it into molds that are placed on a vibration table to remove excess air;
putting the molds with chocolate into a freezer until the chocolate is completely solid.

### BRIEF DESCRIPTION OF THE DRAWINGS

Characteristics and advantages of this technical solution will become obvious from the detailed description given below and the drawings appended hereto as follows:

FIG. 1 depicts a block diagram of a method for cooking dark chocolate with processed buckwheat tea seeds in accordance with non-limiting embodiments of the present technical solution.

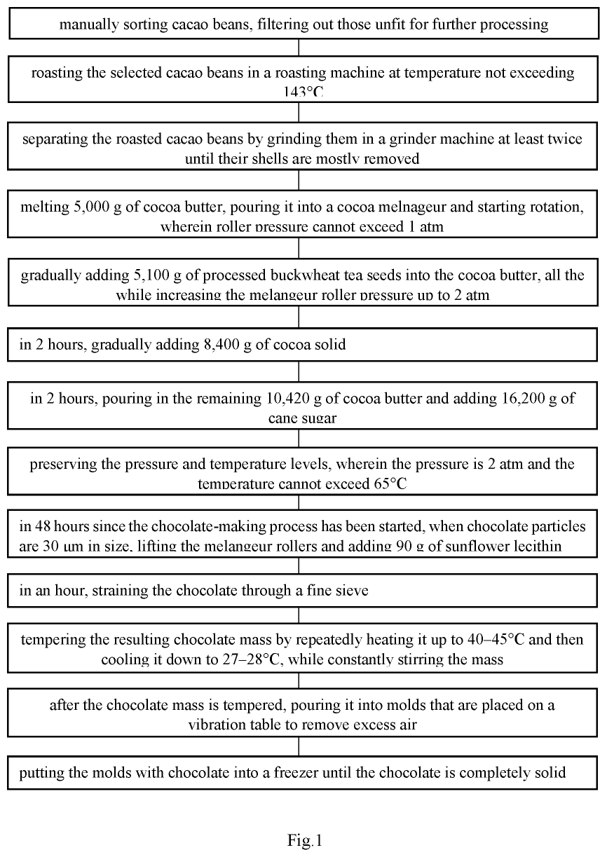

FIG. 2 depicts a block diagram of a method for cooking white chocolate with processed buckwheat tea seeds in accordance with non-limiting embodiments of the present technical solution.

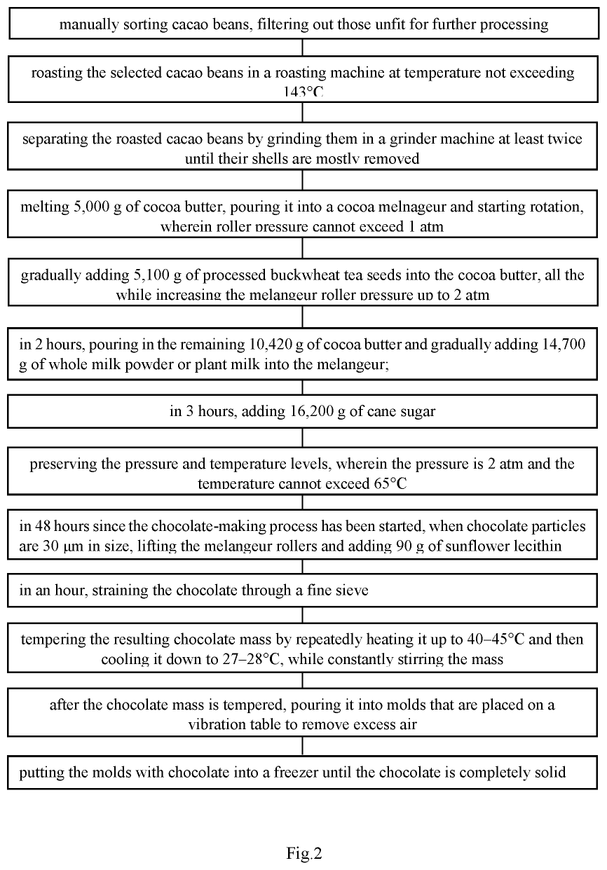

FIG. 3 depicts a block diagram of a method for cooking milk chocolate with processed buckwheat tea seeds in accordance with non-limiting embodiments of the present technical solution.

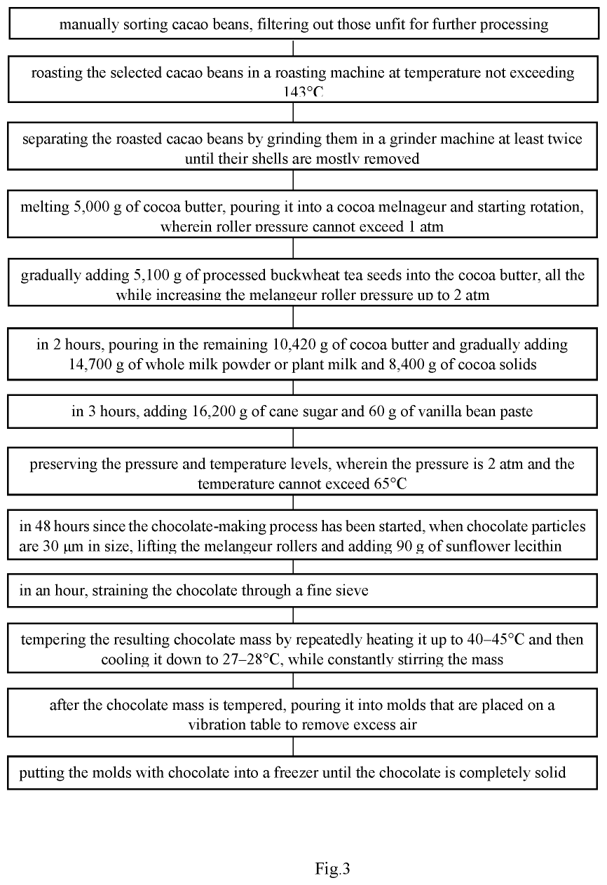

### DETAILED DESCRIPTION

Composition

The original chocolate composition consists of the described structure of components in four (4) variations (embodiments). Every variation (embodiment) includes specially processed buckwheat tea seeds. There are other components, that are included in the composition aside from the seeds of buckwheat tea: cocoa butter (refined or unrefined), cocoa solids, whole milk powder or plant milk, coconut sugar (refined or unrefined), cane sugar (refined or unrefined), sunflower lecithin, pure vanilla bean paste, dry ginger powder, sublimated lemon powder.

The above-mentioned technical result of the technical solution is reached because of the following percentage in the composition that includes natural ingredients:

### Variation (Embodiment) 1. «Dark Chocolate with Processed Buckwheat Tea Seeds»

| | Amount in chocolate |
|---|---|
| Ingredients | composition, % vol. |
| Cocoa solids | 40-44 |
| Cane sugar | 29-31 |
| Cocoa butter | 17-18 |
| Processed buckwheat tea seeds | 9.9-10.8 |
| Sunflower lecithin | 0.1-0.2 |

### Variation (Embodiment) 2. «Milk Chocolate with Processed Buckwheat Tea Seeds»

| | Amount in chocolate |
|---|---|
| Ingredients | composition, % vol. |
| Cocoa butter | 24-25.7 |
| Cane sugar | 25-27 |
| Whole milk powder or plant milk | 23-24.55 |
| Cocoa solids | 14-18 |
| Processed buckwheat tea seeds | 8.5-9 |
| Sunflower lecithin | 0.15-0.25 |
| Pure vanilla bean paste | 0.1-0.2 |

### Variation (Embodiment) 3. «White Chocolate with Processed Buckwheat Tea Seeds»

| | Amount in chocolate |
|---|---|
| Ingredients | composition, % vol. |
| Unrefined cocoa butter | 33.5-36.4 |
| Whole milk powder or plant milk | 30-33 |
| Cane sugar | 25.7-27 |
| Processed buckwheat tea seeds | 6.5-7.6 |
| Sunflower lecithin | 0.1-0.2 |

### Variation (Embodiment) 4. «White Chocolate with Processed Buckwheat Tea Seeds, Ginger, and Lemon»

| | Amount in chocolate |
|---|---|
| Ingredients | composition, % vol. |
| Unrefined cocoa butter | 30-32 |
| Whole milk powder or plant milk | 31.3-33.3 |
| Coconut sugar | 26-27.33 |
| Processed buckwheat tea seeds | 7.2-10 |
| Dry ginger powder | 0.8-1 |
| Sublimated lemon powder | 0.15-0.35 |
| Sunflower lecithin | 0.22-0.35 |

In at least one embodiment unrefined cocoa butter, refined cocoa butter and mix of refined and unrefined cocoa butter can be used.

In at least one embodiment unrefined cane sugar, refined cane sugar and mix of refined and unrefined cane sugar can be used.

In at least one embodiment unrefined coconut sugar, refined coconut sugar and mix of refined and unrefined coconut sugar can be used.

In at least one embodiment chocolate composition may lack whole milk powder or plant milk.

In at least one embodiment instead of whole milk powder or plant milk vegetable milk (or mix of such kinds of milk) can be used.

Examples of vegetable milk or above-mentioned mix can be made of
nuts: almond, cedar, coconut, cashew, pistachio, macadamia, Brazil nut, walnut, pecan, chestnut and hazelnut;
cereal and legumes: rice (white, brown and wild), soy, oat, buckwheat, pea, spelt, barley, millet, quinoa, peanut, teff, amaranth and others;
seeds: poppy, sesame, hemp, chia seeds, sunflower and pumpkin seeds.

Description of Key Composition Ingredients

Use of buckwheat tea in the composition gives the product unique organoleptic and consumer properties:

The buckwheat tea seeds have a pleasant flavor of roasted nuts, which gives chocolate unique taste characteristics that are pleasant to a consumer and differ from ordinary chocolate.

The buckwheat tea seeds do not contain caffeine that negatively affects the cardiovascular system of the human body.

The buckwheat tea seeds include iron, that is necessary for the formation of hemoglobin (red blood cells) and muscle function, magnesium, that stimulates the muscles, including the heart muscle, and is an essential microelement to the normal functioning of blood vessels, vitamins B1 and B2, that also normalize work of the cardiovascular and nervous systems, participate in energy exchange and strengthen the immune system, improve the intestinal function and skin condition, which is important for the people, who lead healthy lifestyle.

The buckwheat tea seeds fill the human body with fiber at rate of 20% of the prescribed norm per day, reduce blood sugar level, so it can be recommended for those who are trying to lose weight or watching weight (also at expense of a low glycemic index). According to research, buckwheat tea and its seeds reduce blood glucose level by 12-19% within one hour and a half or two hours after ingestion. Buckwheat tea seeds contain vitamins A, E and P, which improve the condition of skin, hair and nails.

It is also important to say that the use of buckwheat tea seeds as one of the main components of chocolate composition gives the product almost all the vitamin and mineral complex that the human body needs. It also contains rutin and such amino acids as arginine and lysine, which stimulate immune defense and improve the functioning of the heart and blood vessels.

Buckwheat tea brings diversity to the chocolate compositions, creates an attractive and unusual appearance of chocolate. The use of processed buckwheat tea seeds allows the chocolate product to get a darker color without chemical components. Buckwheat tea increasingly affects the color of final product in Variation 3 (“White chocolate with processed buckwheat tea seeds”) and Variation 4 (“White chocolate with processed buckwheat tea seeds, ginger and lemon”).

In order to achieve the stated technical result, it is necessary to process the buckwheat tea seeds in a manner described below:

The seeds of Tatar buckwheat are harvested, cleaned, ground, pressed, granulated and roasted at a temperature of 60° C. (sixty) until getting dark brown color in the result of roasting.

The use of unrefined cocoa butter allows to preserve the maximum amount of useful qualities in the final product, since cocoa butter does not undergo additional processing;

The presence of unrefined cane sugar is justified for the chocolate compositions because of its useful effect of glucose in its content. Special technological process of the stated raw materials allows to keep the maximum of vitamins and microelements: vitamins of group “B”, phosphorus, calcium, magnesium, iron. The presence of cellulose in the composition of unrefined cane fibers along with vitamins B1, B2, which are part of buckwheat tea, helps to normalize digestion, improve the work of gastrointestinal tract of the human body and metabolism, which is also important in connection with world's trending healthy lifestyle and organic products nutrition.

Unrefined coconut sugar in the chocolate composition contains vitamins B3, B6, potassium, manganese, zinc, iron. Compared to paragraph 2.2. the glycemic index of coconut sugar is 35 (thirty-five). Coconut sugar is enrich with various amino acids, including glutamine, which helps to heal wounds and burns fast, as it contributes to scarring of tissues.

Sunflower lecithin does not cause allergic reactions in the process of consuming chocolate product.

A method for cooking dark chocolate with processed buckwheat tea seeds, comprising the following steps:

At the initial stage of manufacturing manual sorting of cocoa beans is carried out in order to filter out infit (rotten and raw) fruits, so that they do not affect the quality of product and further processing.

Selected cocoa beans are roasted for 10 to 30 minutes (depending on the degree of moisture of cocoa beans) on a roasting machine at a temperature not exceeding 143 (one hundred forty-three) ° C. The temperature is chosen so that excessive drying (or moisture) of cocoa beans, which can make the chocolate tastes sour (or bitter), is avoided.

After roasting cocoa beans are separated. Grinding cocoa beans is carried out on a grinder machine. Roasted cocoa beans are poured in a separator and passed through a crusher until their shells are mostly removed. The shell is removed from the fruits with leaving only clean chopped cocoa solids because of the separation.

The stage of conching begins after separation of cocoa beans. 5,000 g of pre-melted unrefined cocoa butter is poured into a cocoa melangeur. After that rotation starts. Roller pressure cannot exceed 1 (one) atm.

Processed buckwheat tea seeds (tatar buckwheat seeds) in the amount of 5,100 g are gradually added into the cocoa butter. Melangeur roller pressure is increased up to 2 (two) atm with the addition of buckwheat tea seeds.

In two hours, cocoa solids in the amount of 8,400 g are gradually added.

In two hours, the remaining of cocoa butter in the amount of 10,420 g and unrefined cane sugar in the amount of 16,200 g are poured.

Pressure equal to 2 atm and the temperature no higher than 65° C. are preserved.

After reaching the size of chocolate particles in 30 μm in 48 hours after chocolate-making process has started, the melangeur rollers are lifted and sunflower lecithin in the amount of 90 g is added.

An hour later the chocolate is strained through a fine sieve.

After conching the process of tempering the resulting chocolate mass begins. Tempering is a procedure of heating the resulting chocolate mass to a temperature of 40 (forty)-45 (forty-five) ° C. and then cooling down to a temperature of 27 (twenty-seven)-28 (twenty-eight) ° C. while constant stirring. Tempering is carried out until the chocolate mass gets a stable and similar shape.

After tempering, the chocolate mass is poured into molds that are placed on the vibration table, where during shaking excess air is removed from chocolate, which forms bubbles in frozen chocolate.

Molds with chocolate are placed into a freezer until complete solidification.

After complete solidification chocolate bars are packed in the branded packaging, sealed and transferred for sale.

A method for cooking white chocolate with processed buckwheat tea seeds, comprising the following steps:

At the initial stage of manufacturing manual sorting of cocoa beans is carried out in order to filter out infit (rotten and raw) fruits, so that they do not affect the quality of product and further processing.

Selected cocoa beans are roasted for 10 to 30 minutes (depending on the degree of moisture of cocoa beans) on a roasting machine at a temperature not exceeding 143 (one hundred forty-three) ° C. The temperature is chosen so that excessive drying (or moisture) of cocoa beans, which can make the chocolate tastes sour (or bitter), is avoided.

After roasting cocoa beans are separated. Grinding cocoa beans is carried out on a grinder machine. Roasted cocoa beans are poured in a separator and passed through a crusher until their shells are mostly removed. The shell is removed from the fruits with leaving only clean chopped cocoa solids because of the separation.

The stage of conching begins after separation of cocoa beans. 5,000 g of pre-melted unrefined cocoa butter is poured into a cocoa melangeur. After that rotation starts. Roller pressure cannot exceed 1 (one) atm.

Processed buckwheat tea seeds (tatar buckwheat seeds) in the amount of 5,100 g are gradually added into the cocoa butter. Melangeur roller pressure is increased up to 2 (two) atm with the addition of buckwheat tea seeds.

In two hours, the remaining unrefined cocoa butter in the amount of 10,420 g and whole milk powder or plant milk in the amount of 14,700 g and cocoa solids in the amount of 8,400 g are poured.

In three hours, unrefined cane sugar in the amount of 16,200 g is poured and pure vanilla bean paste in the amount of 60 g is added.

Pressure equal to 2 atm (error not more than 0.2 atm in both directions) and the temperature no higher than 65° C. are preserved.

After reaching the size of chocolate particles in 30 μm in 48 hours after the chocolate-making process has started, the melangeur rollers are lifted and sunflower lecithin in the amount of 90 g is added.

An hour later the chocolate is strained through a fine sieve.

After conching the process of tempering the resulting chocolate mass begins. Tempering is a procedure of heating the resulting chocolate mass to a temperature of 40 (forty)-45 (forty-five) ° C. and then cooling down to a temperature of 27 (twenty-seven)-28 (twenty-eight) ° C. while constant stirring. Tempering is carried out until the chocolate mass gets a stable and similar shape.

After tempering, the chocolate mass is poured into molds that are placed on the vibration table, where during shaking excess air is removed from chocolate, which forms bubbles in frozen chocolate.

Molds with chocolate are placed into a freezer until complete solidification.

After complete solidification chocolate bars are packed in the branded packaging, sealed and transferred for sale.

A method for cooking milk chocolate with processed buckwheat tea seeds, comprising the following steps:

At the initial stage of manufacturing manual sorting of cocoa beans is carried out in order to filter out infit (rotten and raw) fruits, so that they do not affect the quality of product and further processing.

Selected cocoa beans are roasted for 10 to 30 minutes (depending on the degree of moisture of cocoa beans) on a roasting machine at a temperature not exceeding 143 (one hundred forty-three) ° C. The temperature is chosen so that excessive drying (or moisture) of cocoa beans, which can make the chocolate tastes sour (or bitter), is avoided.

After roasting cocoa beans are separated. Grinding cocoa beans is carried out on a grinder machine. Roasted cocoa beans are poured in a separator and passed through a crusher until their shells are mostly removed. The shell is removed from the fruits with leaving only clean chopped cocoa solids because of the separation.

The stage of conching begins after separation of cocoa beans. 5,000 g of pre-melted unrefined cocoa butter is poured into a cocoa melangeur. After that rotation starts. Roller pressure cannot exceed 1 (one) atm.

Processed buckwheat tea seeds (tatar buckwheat seeds) in the amount of 5,100 g are gradually added into the cocoa butter. Melangeur roller pressure is increased up to 2 (two) atm with the addition of buckwheat tea seeds.

In two hours, the remaining unrefined cocoa butter in the amount of 10,420 g and whole milk powder or plant milk in the amount of 14,700 g and cocoa solids in the amount of 8,400 g are poured.

In three hours, unrefined cane sugar in the amount of 16,200 g is poured and pure vanilla bean paste in the amount of 60 g is added.

Pressure equal to 2 atm (error not more than 0.2 atm in both directions) and the temperature no higher than 65° C. are preserved.

After reaching the size of chocolate particles in 30 μm in 48 hours after chocolate-making process has started, the melangeur rollers are lifted and sunflower lecithin in the amount of 90 g is added.

An hour later the chocolate is strained through a fine sieve.

After conching the process of tempering the resulting chocolate mass begins. Tempering is a procedure of heating the resulting chocolate mass to a temperature of 40 (forty)-45 (forty-five) ° C. and then cooling down to a temperature of 27 (twenty-seven)-28 (twenty-eight) ° C. while constant stirring. Tempering is carried out until the chocolate mass gets a stable and similar shape.

After tempering, the chocolate mass is poured into molds that are placed on the vibration table, where during shaking the excess air is removed from the chocolate, which forms bubbles in frozen chocolate.

Molds with chocolate are placed into a freezer until complete solidification.

After complete solidification chocolate bars are packed in the branded packaging, sealed and transferred for sale.

A method for cooking white chocolate with processed buckwheat tea seeds, ginger and lemon, comprising the following steps:

At the initial stage of manufacturing manual sorting of cocoa beans is carried out in order to filter out infit (rotten and raw) fruits, so that they do not affect the quality of product and further processing.

Selected cocoa beans are roasted for 10 to 30 minutes (depending on the degree of moisture of cocoa beans) on a roasting machine at a temperature not exceeding 143 (one hundred forty-three) ° C. The temperature is chosen so that excessive drying (or moisture) of cocoa beans, which can make the chocolate tastes sour (or bitter), is avoided.

After roasting cocoa beans are separated. Grinding cocoa beans is carried out on a grinder machine. Roasted cocoa beans are poured in a separator and passed through a crusher until their shells are mostly removed. The shell is removed from the fruits with leaving only clean chopped cocoa solids because of the separation.

The stage of conching begins after separation of cocoa beans. 5,000 g of pre-melted unrefined cocoa butter is poured into a cocoa melangeur. After that rotation starts.

Processed buckwheat tea seeds (tatar buckwheat seeds) in the amount of 5,100 g are being gradually added into the cocoa butter. Melangeur roller pressure is increased up to 2 (two) atm with the addition of buckwheat tea seeds.

In two hours, the remaining unrefined cocoa butter in the amount of 10,420 g and whole milk powder or plant milk in the amount of 14,700 g and dry ginger powder in the amount of 0.8-1% vol. and sublimated lemon powder in the amount of 0.15-0.35% vol. are poured.

In three hours, unrefined coconut sugar in the amount of 16,200 g is poured.

Pressure and the temperature no lower than 55° C. and no higher than 65° C. are preserved.

After reaching the size of chocolate particles in 30 μm in 48 hours after chocolate-making process has started, the melangeur rollers are lifted and sunflower lecithin in the amount of 90 g is added.

An hour later the chocolate is strained through a fine sieve.

After conching the process of tempering the resulting chocolate mass begins. Tempering is a procedure of heating the resulting chocolate mass to a temperature of 40 (forty)-45 (forty-five) ° C. and then cooling down to a temperature of 27 (twenty-seven)-28 (twenty-eight) ° C. while constant stirring. Tempering is carried out until the chocolate mass gets a stable and similar shape.

After tempering, the chocolate mass is poured into molds that are placed on the vibration table, where during shaking the excess air is removed from the chocolate, which forms bubbles in frozen chocolate.

Molds with chocolate are placed into a freezer until the complete solidification.

After complete solidification the chocolate bars are packed in the branded packaging, sealed and transferred for sale.

It should be taken into account that this technical solution is not limited to the above-mentioned exact constructions which are shown in the drawings appended hereto, and that various modifications and supplements can be made without deviation from the field of its application.

What is claimed is:

1. Dark chocolate with processed buckwheat tea seeds, characterized in that it contains chocolate composition components, in the following proportions:

| | Amount in chocolate |
|---|---|
| Ingredients | composition, % vol. |
| Cocoa solids | 40-44 |
| Cane sugar | 29-31 |
| Cocoa butter | 17-18 |
| Processed buckwheat tea seeds | 9.9-10.8 |
| Sunflower lecithin | 0.1-0.2 |

2. Dark chocolate of claim 1, wherein cane sugar is unrefined.

3. Dark chocolate of claim 1, wherein cocoa butter is unrefined.

4. Milk chocolate with processed buckwheat tea seeds, characterized in that it contains chocolate composition components, in the following proportions:

| | Amount in chocolate |
|---|---|
| Ingredients | composition, % vol. |
| Cocoa butter | 24-25.7 |
| Cane sugar | 25-27 |
| Whole milk powder or plant milk | 23-24.55 |
| Cocoa solids | 14-18 |
| Processed buckwheat tea seeds | 8.5-9 |
| Sunflower lecithin | 0.15-0.25 |
| Pure vanilla bean paste | 0.1-0.2 |

5. Milk chocolate of claim 4, wherein cocoa butter is unrefined.

6. Milk chocolate of claim 4, wherein cane sugar is unrefined.

7. White chocolate with processed buckwheat tea seeds, characterized in that it contains chocolate composition components, in the following proportions:

| | Amount in chocolate |
|---|---|
| Ingredients | composition, % vol. |
| Unrefined cocoa butter | 33.5-36.4 |
| Whole milk powder or plant milk | 30-33 |
| Cane sugar | 25.7-27 |
| Processed buckwheat tea seeds | 6.5-7.6 |
| Sunflower lecithin | 0.1-0.2 |

8. White chocolate of claim 7, wherein cocoa butter is unrefined.

9. White chocolate of claim 7, wherein cane sugar is unrefined.

10. White chocolate with processed buckwheat tea seeds, ginger, and lemon, characterized in that it contains chocolate composition components, in the following proportions:

| | Amount in chocolate |
|---|---|
| Ingredients | composition, % vol. |
| Unrefined cocoa butter | 30-32 |
| Whole milk powder or plant milk | 31.3-33.3 |
| Coconut sugar | 26-27.33 |
| Processed buckwheat tea seeds | 7.2-10 |
| Dry ginger powder | 0.8-1 |
| Sublimated lemon powder | 0.15-0.35 |
| Sunflower lecithin | 0.22-0.35 |

11. White chocolate of claim 10, wherein cocoa butter is unrefined.

12. White chocolate of claim 10, wherein coconut sugar is unrefined.

13. A method for cooking dark chocolate with processed buckwheat tea seeds, comprising the following steps:
manually sorting cacao beans, filtering out those unfit for further processing;
roasting the selected cacao beans in a roasting machine at temperature not exceeding 143° C.;
separating the roasted cacao beans by grinding them in a grinder machine at least twice until their shells are mostly removed;
melting 5,000 g of cocoa butter, pouring it into a cocoa melnageur and starting rotation, wherein roller pressure cannot exceed 1 atm;
gradually adding 5,100 g of processed buckwheat tea seeds into the cocoa butter, all the while increasing the melangeur roller pressure up to 2 atm;
in 2 hours, gradually adding 8,400 g of cocoa solids;
in 2 hours, pouring in the remaining 10,420 g of cocoa butter and adding 16,200 g of cane sugar;
preserving the pressure and temperature levels, wherein the pressure is 2 atm and the temperature cannot exceed 65° C.;
in 48 hours since the chocolate-making process has been started, when chocolate particles are 30 μm in size, lifting the melangeur rollers and adding 90 g of sunflower lecithin;
in an hour, straining the chocolate through a fine sieve;
tempering the resulting chocolate mass by repeatedly heating it up to 40-45° C. and then cooling it down to 27-28° C., while constantly stirring the mass;
after the chocolate mass is tempered, pouring it into molds that are placed on a vibration table to remove excess air;
putting the molds with chocolate into a freezer until the chocolate is completely solid.

14. A method for cooking white chocolate with processed buckwheat tea seeds, comprising the following steps:
manually sorting cacao beans, filtering out those unfit for further processing;
roasting the selected cacao beans in a roasting machine at temperature not exceeding 143° C.;
separating the roasted cacao beans by grinding them in a grinder machine at least twice until their shells are mostly removed;
melting 5,000 g of cocoa butter, pouring it into a cocoa melnageur and starting rotation, wherein roller pressure cannot exceed 1 atm;
gradually adding 5,100 g of processed buckwheat tea seeds into the cocoa butter, all the while increasing the melangeur roller pressure up to 2 atm;
in 2 hours, pouring in the remaining 10,420 g of cocoa butter and gradually adding 14,700 g of whole milk powder or plant milk into the melangeur;
in 3 hours, adding 16,200 g of cane sugar;
preserving the pressure and temperature levels, wherein the pressure is 2 atm and the temperature cannot exceed 65° C.;
in 48 hours since the chocolate-making process has been started, when chocolate particles are 30 μm in size, lifting the melangeur rollers and adding 90 g of sunflower lecithin;
in an hour, straining the chocolate through a fine sieve;
tempering the resulting chocolate mass by repeatedly heating it up to 40-45° C. and then cooling it down to 27-28° C., while constantly stirring the mass;
after the chocolate mass is tempered, pouring it into molds that are placed on a vibration table to remove excess air;
putting the molds with chocolate into a freezer until the chocolate is completely solid.

15. A method for cooking milk chocolate with processed buckwheat tea seeds, comprising the following steps:
manually sorting cacao beans, filtering out those unfit for further processing;
roasting the selected cacao beans in a roasting machine at temperature not exceeding 143° C.;
separating the roasted cacao beans by grinding them in a grinder machine at least twice until their shells are mostly removed;
melting 5,000 g of cocoa butter, pouring it into a cocoa melnageur and starting rotation, wherein roller pressure cannot exceed 1 atm;
gradually adding 5,100 g of processed buckwheat tea seeds into the cocoa butter, all the while increasing the melangeur roller pressure up to 2 atm;
in 2 hours, pouring in the remaining 10,420 g of cocoa butter and gradually adding 14,700 g of whole milk powder or plant milk and 8,400 g of cocoa solids;
in 3 hours, adding 16,200 g of cane sugar and 60 g of vanilla bean paste;
preserving the pressure and temperature levels, wherein the pressure is 2 atm and the temperature cannot exceed 65° C.;
in 48 hours since the chocolate-making process has been started, when chocolate particles are 30 μm in size, lifting the melangeur rollers and adding 90 g of sunflower lecithin;
in an hour, straining the chocolate through a fine sieve;
tempering the resulting chocolate mass by repeatedly heating it up to 40-45° C. and then cooling it down to 27-28° C., while constantly stirring the mass;
after the chocolate mass is tempered, pouring it into molds that are placed on a vibration table to remove excess air;
putting the molds with chocolate into a freezer until the chocolate is completely solid.
